(19) United States
(12) Patent Application Publication
(10) Pub. No.: US 2025/0363514 A1
(43) Pub. Date: Nov. 27, 2025

(54) DEVICE AND METHOD FOR CALCULATING POWER MARKET PRICE BASED ON PHOTOVOLTAIC POWER GENERATION

(71) Applicant: HANWHA SOLUTIONS CORPORATION, Seoul (KR)

(72) Inventors: Jung Woo SEO, Seoul (KR); Dong-Hyun KIM, Seoul (KR); Sang Woo SHIM, Seoul (KR)

(73) Assignee: HANWHA SOLUTIONS CORPORATION, Seoul (KR)

(21) Appl. No.: 19/203,248

(22) Filed: May 9, 2025

(30) Foreign Application Priority Data
May 22, 2024 (KR) 10-2024-0066721

(51) Int. Cl. G06Q 30/0201; G01W 1/10; G06Q 50/06; H02J 3/00; H02J 3/38

(52) U.S. Cl. CPC G06Q 30/0206; G06Q 50/06; H02J 3/003; H02J 3/004; H02J 3/38; G01W 1/10; H02J 2203/20; H02J 2300/24

(57) ABSTRACT

A device for calculating a power market price based on photovoltaic power generation according to embodiments includes at least one processor and at least one memory operably connected to the processor, in which the at least one processor is configured to generate next day power demand estimation data of a target area, generate next day power demand estimation data of a non-target area, generate next day SMP estimation data of the non-target area, generate next day power generation planning estimation data of the target area, and calculate next day SMP data of the target area.

### CROSS-REFERENCE TO RELATED APPLICATION

This application is based on and claims priority under 35 U.S.C. § 119 to Korean Patent Application No. 10-2024-0066721, filed on May 22, 2024, in the Korean Intellectual Property Office, the disclosure of which is incorporated by reference herein in its entirety.

### BACKGROUND

### 1. Field

The disclosure relates to a device and method for calculating a power market price based on photovoltaic power generation.

### 2. Description of the Related Art

Globally, power markets require a variety of power demand estimation, pricing mechanisms, and efficient power plant operation. In particular, power markets use pricing models, such as the system marginal price (SMP) model, to ensure economic power supply while maintaining system stability.

In order to respond to new challenges resulting from the growth of renewable energy including photovoltaic energy, changing consumer energy consumption patterns, and technological advances, it is necessary to effectively manage and optimize the dynamics of the power market, such as power supply and demand, pricing, policy and regulatory changes, technological advances, and changes in consumer behavior. In particular, the volatility of photovoltaic energy and the resulting increased complexity of system operations further emphasizes the need for accurate generation planning and pricing models.

The above background technology is technical information that the inventor(s) possessed for conceiving of the disclosure or acquired in the process of conceiving of the disclosure, and should not be considered to be prior art already known to the public prior to the filing of the disclosure.

### SUMMARY

An objective of the disclosure is to calculate a power market price for a target area based on an estimated power generation plan which reflects the power supply and demand characteristics of the target area.

The objective of the disclosure is not limited to the above-described description, and other objectives and advantages not explicitly disclosed herein will be clearly understood from the following description, and will be understood more clearly according to embodiments of the disclosure. It will also be appreciated that the above and other objectives and advantages of the disclosure may be realized by means disclosed in the claims and combinations thereof.

A device for calculating a power market price based on photovoltaic power generation according to embodiments includes: at least one processor; and at least one memory operably connected to the processor, wherein the at least one processor is configured to: analyze date data, meteorological data, and past power demand data to generate next day power demand estimation data of a target area; analyze date data, meteorological data, and past power demand data to generate next day power demand estimation data of a non-target area; analyze the next day power demand estimation data, the date data, the meteorological data, the past power demand data, and past system marginal price (SMP) data to generate next day SMP estimation data of the non-target area; analyze the next day power demand estimation data of the target area, generator characteristics data, and system constraint data to generate next day power generation planning estimation data of the target area; and analyze the next day power generation planning estimation data of the target area, the system constraint data, the generator characteristics data, and the next day SMP estimation data of the non-target area to calculate next day SMP data of the target area.

A method of calculating a power market price based on photovoltaic power generation is a method of calculating a power market price performed by a process of a power market price calculation device, the method including: analyzing date data, meteorological data, and past power demand data to generate next day power demand estimation data of a target area; analyzing date data, meteorological data, and past power demand data to generate next day power demand estimation data of a non-target area; analyzing the next day power demand estimation data, the date data, the meteorological data, the past power demand data, and past SMP data to generate next day SMP estimation data of the non-target area; analyzing the next day power demand estimation data of the target area, generator characteristics data, and system constraint data to generate next day power generation planning estimation data of the target area; and analyzing the next day power generation planning estimation data of the target area, the system constraint data, the generator characteristics data, and the next day SMP estimation data of the non-target area to calculate next day SMP data of the target area.

Furthermore, other methods and other systems for implementing the disclosure and a computer-readable recording medium on which a computer program for executing the methods is stored may also be provided.

Other aspects, features, and advantages than those described above will become apparent from the following drawings, claims, and detailed description of the disclosure.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a block diagram schematically illustrating the configuration of a device for calculating a power market price based on photovoltaic power generation according to embodiments;

FIG. 2 is a detailed diagram illustrating the device for calculating a power market price based on photovoltaic power generation shown in FIG. 1;

FIG. 3 is a block diagram schematically illustrating the configuration of the SMP calculator in FIGS. 1 and 2;

FIG. 4 is a block diagram schematically illustrating the configuration of a device for calculating a power market price based on photovoltaic power generation according to other embodiments; and

FIG. 5 is a flowchart illustrating a method of calculating a power market price based on photovoltaic power generation according to embodiments.

### DETAILED DESCRIPTION

Advantages and features of the disclosure, as well as methods of realizing the same, will be more clearly understood from the following detailed description of embodiments when taken in conjunction with the accompanying drawings. However, it should be understood that the disclosure is not limited to specific embodiments described below but may be embodied in a variety of different forms and include all various modifications, equivalents, and substitutions that may be within the spirit and scope of the disclosure. The following embodiments are provided so that the disclosure will be thorough and complete, and will fully convey the scope of the disclosure to a person of ordinary knowledge in the art to which the disclosure relates. In describing the disclosure, a detailed description of related known technology may be omitted in case that it is determined that the gist of the disclosure may be obscured thereby.

Terms used in this application are used to describe a particular embodiment and are not intended to limit the disclosure. Singular forms may include plural forms unless the context clearly indicates otherwise. In this application, the terms “comprise”, “include”, or “have” should be understood to indicate that a feature, a number, a step, an operation, a component, a part, or a combination thereof described in the specification is present, but does not preclude the possibility of the presence or addition of one or more other features, numbers, steps, operations, components, parts, or combinations thereof in advance. The terms “first”, “second”, or the like may be used to describe various elements, but these elements should not be limited by these terms. These terms are used only to distinguish one element from another element.

In this application, the term “part” or “portion” may be a hardware component, such as a processor or a circuit, and/or a software component executed by the hardware component such as a processor.

In this application, the term “target area” may refer to an area of primary interest in the calculation of the power market price. The target area refers to Jeju Island, and Jeju Island as a target area may be considered separately in calculating the power market price. Jeju Island has unique power supply and demand characteristics, which may be an important variable in the power price calculation process. Furthermore, generators in the target area may include one or more generators disposed on Jeju Island.

In this application, the term “non-target area” may refer to the rest area other than the target area, Jeju Island, i.e., may refer to the mainland of the Republic of Korea. In this embodiment, the non-target area may include metropolitan cities such as Seoul, Gwangju, Daegu, Daejeon, Busan, and Incheon. The mainland, i.e., the non-target area, has different power supply and demand conditions and market mechanisms than Jeju Island, and may be considered separately from the target area in the power market price calculation. Furthermore, the generators in the non-target area may include one or more generators disposed in Seoul, Gwangju, Daegu, Daejeon, Busan, and Incheon.

In this application, artificial intelligence algorithms may be used for the calculation of the power market price. As used herein, artificial intelligence (AI) is a branch of computer science and information technology which studies how to enable computers to think, learn, evolve, etc. like human intelligence, and may mean enabling computers to mimic human intelligent behavior. Furthermore, AI does not exist on its own, but has many direct and indirect connections to other fields of computer science. In particular, there are currently active attempts in various fields of information technology to introduce and use AI elements to solve problems in these fields. Machine learning is a branch of artificial intelligence, which may include fields of research which enable computers to learn without being explicitly programmed. Specifically, machine learning may be a technology for studying and building systems which learns, makes an estimation, and improves their own performance based on empirical data and algorithms for these systems. Instead of executing a strict set of static program instructions, machine learning algorithms may be configured to build specific models to make estimations or decisions based on input data. Machine learning methods for these neural networks may use both unsupervised and supervised learning. Deep learning techniques, a type of machine learning, may enable data-based learning at a deep level through multiple layers. Deep learning may refer to a set of machine learning algorithms which extract core data from a plurality of pieces of data as the number of layers increases.

Hereinafter, embodiments of the disclosure will be described in detail with reference to the accompanying drawings, in which identical or corresponding components will be designated by the same reference numerals and repeated descriptions thereof will be omitted.

In the following embodiments, terms, such as first and second, as used herein do not have a limited meaning but are used for the purpose of distinguishing one component from another.

In the following embodiments, singular forms include plural referents unless the context clearly indicates otherwise.

In the following embodiments, terms, such as “comprise/include” or “have”, are intended to imply the presence of a feature or a component described in the specification and do not preclude the possibility that one or more other features or components may be added.

In a case that a particular embodiment may be implemented differently, a particular process order may be changed from the described order. For example, two sequentially described processes may be performed substantially at the same time or in an order opposite to the described order.

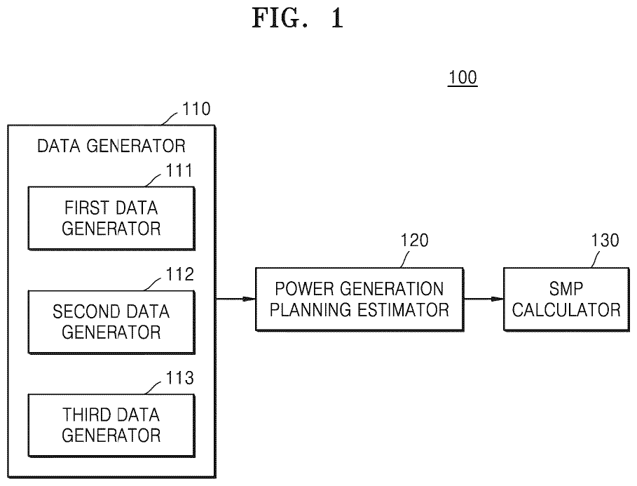

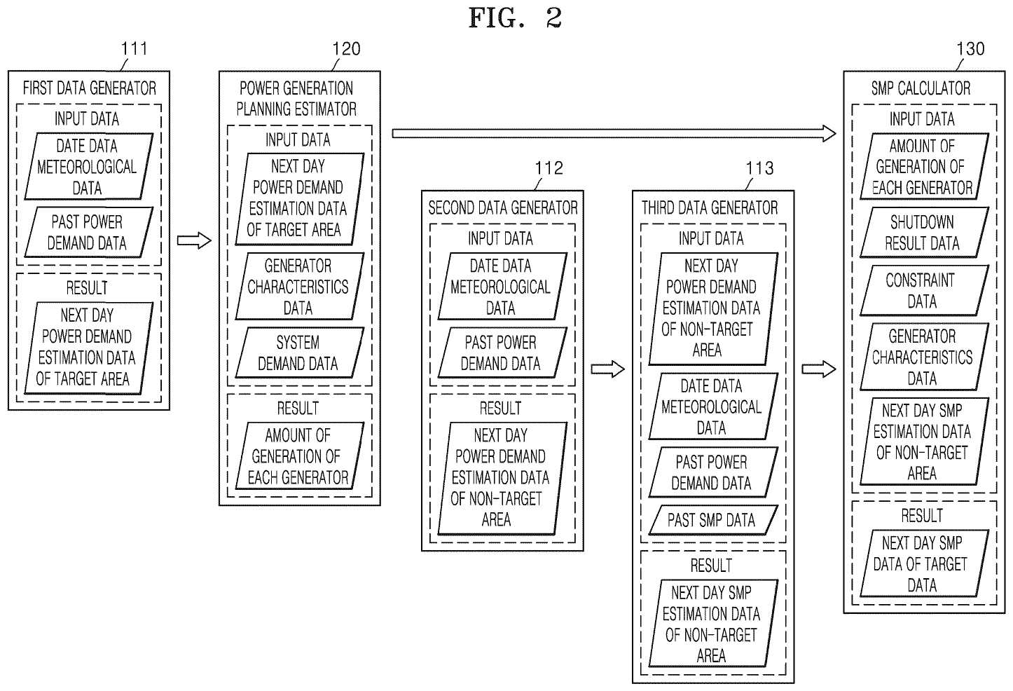

FIG. 1 is a block diagram schematically illustrating the configuration of a device for calculating a power market price based on photovoltaic power generation according to embodiments, and FIG. 2 is a detailed diagram illustrating the device for calculating a power market price based on photovoltaic power generation shown in FIG. 1. Referring to FIGS. 1 and 2, a device 100 for calculating a power market price based on photovoltaic power generation (hereinafter referred to as a power market price calculation device) may include a data generator 110, a power generation planning estimator 120, and an SMP calculator 130.

The data generator 110 may perform comprehensive data analysis and processing operations, including power demand estimation for target and non-target areas and SMP estimation for non-target areas. The data generator 110 may generate accurate and reliable data to support pricing decisions in the power market and provide fundamental information essential for optimizing power supply planning.

In this embodiment, the data generator 110 may include a first data generator 111, a second data generator 112, and a third data generator 113.

The first data generator 111 may analyze date data, meteorological data, and past power demand data to generate power demand estimation data for the next day of a target area. In this embodiment, the date data may include a month and an hour for which the estimation data is to be generated. In this embodiment, the meteorological data may include respective average values of temperature, precipitation, wind speed, snowfall, solar radiation, and cloud cover of a target area included in the date data. In this embodiment, the meteorological data may be collected from a weather bureau. The past power demand data may include actual power demand data of the target area up to the previous day from a past day more distant than the previous day.

In this embodiment, the first data generator 111 may generate next day power demand estimation data of the target area corresponding to the date data, the meteorological data, and the past power demand data using a first machine learning model which generates the next day power demand estimation data of the target area based on the date data, the meteorological data, and the past power demand data. Here, the first machine learning model may be a model trained by a supervised learning method using training data having the date data, the meteorological data of the target area, and the past power demand data of the target area as an input and the next day power demand data of the target area as labels.

The first data generator 111 may train the initially set first machine learning model by the supervised learning method using labeled first training data. Here, the initially set first machine learning model may be an initial model designed to be configured as a model capable of estimating the next day power demand data of the target area from the date data, the meteorological data of the target area, and the past power demand data of the target area, and may be in a state in which the parameter values are set to arbitrary initial values. The initial model may be trained using the first training data described above, with the parameter values being optimized, to result in a first estimation model capable of accurately estimating the next day power demand data of the target area in response to the date data, the meteorological data of the target area, and the past power demand data of the target area.

The second data generator 112 may analyze date data, meteorological data, and past power demand data to generate next day power demand estimation data of a non-target area. In this embodiment, the date data may include a month and an hour for which the estimation data is to be generated. In this embodiment, the meteorological data may include respective average values of temperature, precipitation, wind speed, snowfall, solar radiation, and cloud cover of the non-target area included in the date data. The past power demand data may include the power demand of the non-target area up to the previous day from a past day more distant than the previous day.

In this embodiment, the date data, the meteorological data, and the past power demand data analyzed by the second data generator 112 to generate the next day power demand estimation data of the non-target area may be different from the date data, meteorological data, and past power demand data analyzed by the first data generator 111 to generate the next day power demand estimation data of the target area. For this reason, “the” may be excluded from the date data, the meteorological data, and the past power demand data in the generating the next day power demand estimation data of the non-target area as set forth in claim 1 to be described later. In an optional embodiment, at least one of the date data, the meteorological data, or the past power demand data analyzed by the second data generator 112 to generate the next day power demand estimation data of the non-target area may be the same as the date data, the meteorological data, and the past power demand data analyzed by the first data generator 111 to generate the next day power demand estimation data of the target area. For this reason, at least one of the date data, the meteorological data, and the past power demand data may be designated as “the” in the generating the next day power demand estimation data of the non-target area as set forth in claim 1 to be described later.

In this embodiment, the second data generator 112 may generate the next day power demand estimation data of the non-target area corresponding to the date data, the meteorological data, and the past power demand data using the modified first machine learning model which generates the next day power demand estimation data of the non-target area based on the date data, the meteorological data, and the past power demand data. Here, the modified first machine learning model may be a model trained by the supervised learning method using training data having the date data, the meteorological data of the non-target area, the past power demand data of the non-target area as an input and the next day power demand data of the non-target area as labels.

The third data generator 113 may analyze the next day power demand estimation data of the non-target area, the date data, the meteorological data, the past power demand data, and the past SMP data to generate the next day SMP estimation data of the non-target area. In this embodiment, the next day power demand estimation data of the non-target area may be received from the second data generator 112. In this embodiment, the date data may include a month and an hour for which the estimation data is to be generated. In this embodiment, the meteorological data may include respective average values of temperature, precipitation, wind speed, snowfall, solar radiation, and cloud cover for the target area included in the date data. In this embodiment, the meteorological data may be collected from a weather bureau. The past power demand data may include actual power demand data of the non-target area up to the previous day from a past day more distant than the previous day. The past SMP data may include actual SMP data of the non-target area up to the previous day from a past day more distant than the previous day.

In this embodiment, the date data, the meteorological data, and the past power demand data analyzed by the third data generator 113 to generate the next day SMP estimation data of the non-target area may be different from the date data, the meteorological data, and the past power demand data analyzed by the second data generator 112 to generate the next day power demand estimation data of the non-target area, and may be different from the date data, the meteorological data, and the past power demand data analyzed by the first data generator 111 to generate the next day power demand estimation data of the target area. For this reason, “the” may be excluded from the date data, the meteorological data, and the past power demand data in the generating the next day SMP estimation data of the non-target area as set forth in claim 1 to be described later. In an optional embodiment, at least one of the date data, the meteorological data, or the past power demand data analyzed by the third data generator 113 to generate the next day SMP estimation data of the non-target area may be the same as the date data, the meteorological data, and the past power demand data analyzed by the second data generator 112 to generate the next day power demand estimation data of the non-target area. In such a case, at least one of the date data, the meteorological data, and the past power demand data may be designated as “the” in the generating the next day SMP estimation data of the non-target area as set forth in claim 1 to be described later.

The third data generator 113 may generate the next day SMP estimation data of the non-target area corresponding to the next day power demand estimation data, the date data, the meteorological data, the past power demand data, and the past SMP data using a second machine learning model which generates the next day SMP estimation data of the non-target area based on the next day power demand estimation data of the non-target area, the date data, the meteorological data, the past power demand data, and the past SMP data. The second machine learning model may be a model trained by the supervised learning method using second training data having the next day power demand estimation data of the non-target area, the date data, the meteorological data of the non-target area, the past power demand data of the non-target area, and the past SMP data of the non-target area as an input and the next day SMP estimation data of the non-target area as a label.

The third data generator 113 may use the labeled second training data to train the initially established second machine learning model by the supervised learning method. Here, the initially established second machine learning model may be an initial model designed to be configured as a model capable of estimating next day SMP data of the non-target area from the next day power demand estimation data of the non-target area, the date data, the meteorological data, the past power demand data, and the past SMP data, and may be in a state in which the parameter values are set to arbitrary initial values. The initial model may be trained using the second training data described above, with the parameter values being optimized, to be completed as a second estimation model capable of accurately estimating the next day SMP data of the non-target area based on the next day power demand estimation data of the non-target area, the date data, the meteorological data of the non-target area, the past power demand data of the non-target area, and the past SMP data of the non-target area.

The power generation planning estimator 120 may analyze the next day power demand estimation data, the generator characteristics data, and the system constraint data of the target area to generate next day power generation planning estimation data of the target area. In this embodiment, the next day power generation planning estimation data of the target area may include the next day power generation amounts of generators disposed in the target area and next day shutdown results of the generators. In this embodiment, the next day power demand estimation data of the target area may be received from the first data generator 111.

In this embodiment, the generator characteristics data of the target area may include generation cost data and generator bidding data. Here, the generation cost data may include a generator cost function, a generator minimum output, a generator maximum output, a generator minimum run time, a generator minimum downtime, generator ramp up/down rates, a generator startup time, a generator frequency following theoretical value, a generator frequency control reserve available capacity, a transmission loss factor, a calorific unit price, high-voltage direct current (HVDC) transmission, and the like. The generator cost function may include the coefficients of a quadratic price characteristic curve representing the relationship between the generator output and the fuel cost. The generator minimum output may include the minimum capacity which the generator must generate to maintain stable operation. The generator maximum output may include the maximum capacity that the generator may generate relative to the high side of a main transformer. The generator minimum run time may include a minimum time interval from the time that the generator is connected to the system to the time that the generator is disconnected from the system. The generator minimum downtime may include a minimum time interval from the time that the generator is disconnected from the system to the time that the generator may be connected to the system. The generator ramp up/down rates may include the ability of the generator to increase and decrease outputs. The generator startup time may include the time required to start the generator. The generator frequency following theoretical value may include a frequency following theoretical value which is responsive to a change in a selected frequency (e.g., 0.2 Hz) based on a generator-specific speed regulation rate characteristic. The generator frequency control reserve available capacity may include a generator-specific frequency control reserve available capacity. The transmission loss factor may include a transmission loss rate along the transmission line from the transmission end of the generator to a position where a gauge is disposed. The calorific unit price may include a fuel price per unit calorie. The HVDC is a system able to efficiently transmit large amounts of power over long distances, and may include process of converting electricity into high-voltage direct current (DC) for transmission and then converting the DC back into low-voltage alternating current (AC) at the point of use. The generator bidding data may also be submitted by generating companies to a power market organization or a power exchange. The generator bidding data may include maximum amounts of power which respective generating companies may supply to the market, prices per unit of power (kW) for respective times of day which the generating companies are offering, time periods during which the generating companies are available to supply power, and the like. The generator bidding data may also include a fixed constrained operating amount and a lower constrained operating amount, in which the fixed constrained operating amount represents the minimum generating capacity which the generator must maintain during a specific time period, and the lower constrained operating amount represents the lower bound of the minimum generating capacity which the generator must maintain while operating in the market.

In this embodiment, the system constraint data of the target area may include operating reserve data and system constrained operating generator data. The operating reserve data may include additional generating capacity which is maintained to balance power demand and supply and to respond to emergency situations, such as unexpected increases in power demand or generator failures. In this embodiment, the operating reserve of the target area may be applied differently than the operating reserve of the non-target area. The operating reserve of the target area may be divided into normal-time operating reserve and failure-time operating reserve. The normal-time operating reserve is a frequency control reserve which may increase the generation power of the operating generator up to 20 MW in 5 minutes. The normal-time operating reserve may be obtained by automatic generation control (AGC) and the HVDC, and the obtained reserve may be maintained for up to 30 minutes. The failure-time operating reserve may include three operating reserves. The primary reserve may provide up to 15 MW of generation power by which the GF operating generator may ramp up in 10 seconds, and may be obtained by the HVDC. The primary reserve may correspond to initial power supply interruptions, and may be maintained for five minutes. The secondary reserve may be activated by the AGC in 10 minutes, and may be maintained for 30 minutes to support power supply during intermediate periods. The tertiary reserve may be activated in 30 minutes by the operating generators and the HVDC, and may provide a significant amount of additional power of 100 MW. Furthermore, explaining the system constrained operating generator data, an essential operating generator may be selected in the target area for stable operation of the system by considering high variability of renewable energy. The selection of the essential operating generator may be reflected by modifying transmission constraints in establishing daily power generation planning, and in particular, the minimum number of operating generators may be determined by considering the use ratio of photovoltaic power and the ripple effect of failures. During the day, in case that photovoltaic use rate is equal to or greater than 10% or a failure propagation stop amount is equal to or greater than 50 MW, four or more generators may be selected to operate so that at least one generator operates in each of the southern and northern regions of the target area. During the night, three or more generators may be selected to operate, differently from the day, so that at least one generator operates in each of the southern and northern regions of the target area.

The power generation planning estimator 120 may generate the next day power generation planning estimation data of the target area corresponding to the next day power demand estimation data of the target area, the generator characteristics data, and the system constraint data using a third machine learning model which generates the next day power generation planning estimation data of the target area based on the next day power demand estimation data of the target area, the generator characteristics data, and the system constraint data. Here, the third machine learning model may be a model trained by the supervised learning method using third training data having the next day power demand estimation data of the target area, the generator characteristics data of the target area, and the system constraint data of the target area as an input and the power generation planning data of the target area, including next day power generation amounts of generators disposed in the target area and next day shutdown results of the generators, as a label.

The power generation planning estimator 120 may use the labeled third training data to train the initially established third machine learning model by the supervised learning method. Here, the initially established third machine learning model may be an initial model designed to be configured as a model capable of estimating the next day power generation planning data of the target area from the next day power demand estimation data of the target area, the generator characteristics data of the target area, and the system constraint data of the target area, and may be in a state in which the parameter values are set to arbitrary initial values. The initial model may be trained using the third training data described above, with the parameter values being optimized, to be completed as a third estimation model capable of accurately estimating the next day power generation planning data of the target area based on the generator characteristics data of the target area and the system constraint data of the target area.

The SMP calculator 130 may calculate the next day SMP data of the target area by analyzing the next day power generation planning estimation data of the target area, the system constraint data of the target area, the generator characteristics data of the target area, and the next day SMP estimation data of the non-target area.

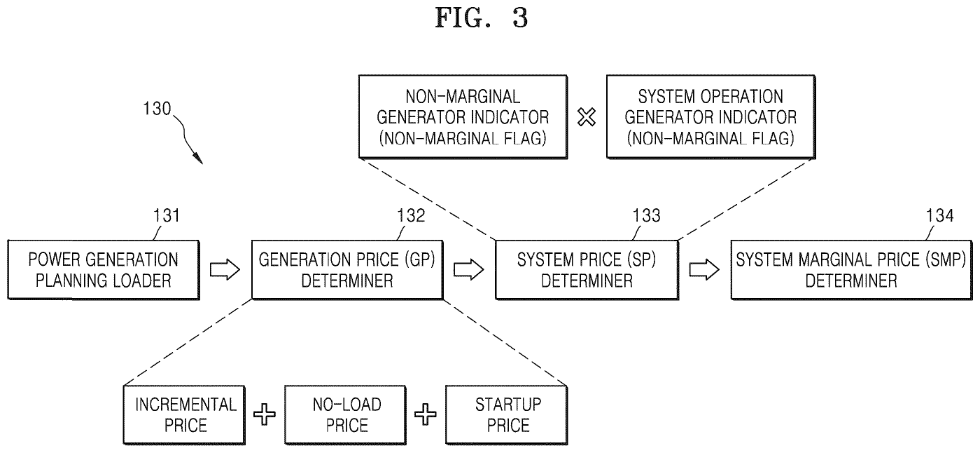

FIG. 3 is a block diagram schematically illustrating the configuration of the SMP calculator 130 in FIGS. 1 and 2. Referring to FIG. 3, the SMP calculator 130 may include a power generation planning loader 131, a generation price (GP) determiner 132, a system price (SP) determiner 133, and a system marginal price determiner 134.

The power generation planning loader 131 may load the power generation planning estimation data of the target area, including the next day power generation amounts of the generators disposed in the target area and the next day shutdown results of the generators, from the power generation planning estimator 120.

The generation price determiner 132 may determine a generation price for each of a plurality of generators included in a generator group based on the next day power generation planning estimation data of the target area, the system constraint data, and the generator characteristic data. In this embodiment, the generation price determiner 132 may determine the result of summing the first price, the second price, and the third price to be a generation price. In this embodiment, the first price may include an incremental price, which may represent a cost incurred to increase the generator's daily generation amount included in the next day power generation planning estimation data of the target area. The second price may include a no-load price, which may represent a cost incurred to compensate for a fuel cost deficit which may not be recovered using the incremental price alone. Furthermore, the third price may include a startup price, which may represent a cost incurred to start up the generator disposed in the target area.

The generation price determiner 132 may exclude the second price and the third price from the generation price based on the generator bidding data included in the generator characteristic data as one of the fixed constrained operating amount and the lower constrained operating amount is bid in the continuous startup time. In such a case, the generation price may be determined based only on the first price.

The generation price determiner 132 may exclude the second price and the third price from the generation prices of the generators which must be operated essentially based on the system constraint data as the total number of operating generators included in the generator group is less than or equal to the number of essentially operating generators in the generator group. In such a case, the generation price may be determined based only on the first price.

The system price determiner 133 may receive the generation price for each of the plurality of generators determined by the generation price determiner 132, and may determine system prices based on the operating characteristics of the generators. The system price determiner 133 may determine one or more of the respective generation prices for the plurality of generators which satisfy the pricing conditions to be the one or more system prices. For example, the system price determiner 133 may exclude one or more of the respective generation prices for the plurality of generators which do not satisfy the pricing conditions from the system prices, and then determine the remaining one or more of the generation prices to be one or more system prices.

The system price determiner 133 may exclude a generation price of the non-marginal generator indicator and a generation price from the system operation generator indicator which does not satisfy the pricing conditions from the system prices, based on the generator characteristic data and the system constraint data.

In this embodiment, the non-marginal generator indicator may include a generator which is necessary to satisfy power demand but is not necessary to calculate the system marginal price. For example, the non-marginal generator indicator may include a generator which has minimum operating constraints or has a relatively low production cost, such as due to renewable energy, to be free from power market volatility or competition. There may be four cases where a generator does not satisfy the pricing conditions in the non-marginal generator indicator. In the first case, generators may be planned to generate an amount of power which is less than or equal to the sum of a minimum capacity, a planned amount of primary reserve, a planned amount of frequency control reserve, and a tolerance. In the second case, generators may be planned to generate an amount of power which is less than or equal to the sum of fixed constrained operating amounts for times of day and a lower constrained capacity plus the tolerance. In the third case, a generator may be power generation planned to ramp up at full rate. In the fourth case, generators may be power generation planned to ramp down at full rate. The generation prices of the generators included in these four cases may be excluded from the system prices.

In this embodiment, the system operating generator indicator may include generators which are essential to reliable operation of the power grid. The system operating generators perform functions critical to system operation, such as power grid stability, frequency regulation, and voltage support, and may sometimes be specifically activated to provide power in emergency situations. The system operating generators perform an essential role in the power market, but the system operating generators may prioritize the stability and safety of the grid over market mechanisms. The system operating generator indicator may include two cases where a generator does not satisfy the pricing conditions. In the first case, a plurality of generators included in a generator group may be power generation planned such that the total of generation of the generators is less than or equal to the minimum generation for each time of day of the generator group. In the second case, generators may be power generation planned to additionally operate to stabilize the power supply. The generation prices of the generators included in these two cases may be excluded from the system prices.

The system marginal price determiner 134 may determine the highest value of one or more system prices received from the system price determiner 133 to be the next day system marginal price for the target area.

In an optional embodiment, the SMP calculator 130 may estimate the next day SMP data of the target area corresponding to the next day power generation planning estimation data of the target area, the system constraint data of the target area, the generator characteristics data of the target area, and the next day SMP estimation data of the non-target area using a fourth machine learning model which estimates the next day SMP data of the target area based on the next day power generation planning estimation data of the target area, the system constraint data of the target area, the generator characteristics data of the target area, and the next day SMP estimation data of the non-target area. Here, the fourth machine learning model may be a model trained by the supervised learning method using fourth training data having the next day power generation planning estimation data of the target area, the system constraint data of the target area, the generator characteristics data of the target area, and the next day SMP estimation data of the non-target area as an input and the next day SMP data of the target area as a label.

The SMP calculator 130 may train the initially set fourth machine learning model by the supervised learning method using the labeled fourth training data. Here, the initially set fourth machine learning model may be an initial model designed to be configured as a model capable of estimating the next day SMP data of the target area from the next day power generation planning estimation data of the target area, the system constraint data of the target area, the generator characteristics data of the target area, and the next day SMP estimation data of the non-target area, and may be in a state in which the parameter values are set to arbitrary initial values. The initial model may be trained using the fourth training data described above, with the parameter values being optimized, to be completed as a fourth estimation model capable of accurately estimating the next day SMP data of the target area based on the next day power generation planning estimation data of the target area, the system constraint data of the target area, the generator characteristics data of the target area, and the next day SMP estimation data of the non-target area.

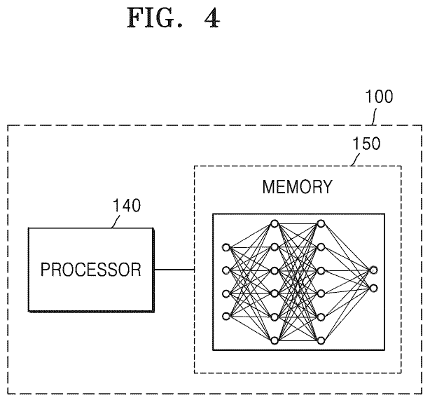

FIG. 4 is a block diagram schematically illustrating the configuration of a device for calculating a power market price based on photovoltaic power generation according to other embodiments. In the following description, some portions which are the same as those described with reference to FIGS. 1 to 3 will be omitted. Referring now to FIG. 4, the power market price calculation device 100 according to other embodiments may include a processor 140 and a memory 150.

In this embodiment, the processor 140 may perform the functions performed by the data generator 110, the power generation planning estimator 120, and the SMP calculator 130 disclosed in FIGS. 1 to 3.

Such a processor 140 may control the overall operation of the power market price calculation device 100. As used herein, the term “processor” may refer to a hardware-embedded data processing device, for example, having physically structured circuitry to perform functions expressed as code or instructions contained in a program. Examples of the hardware-embedded data processing device may include processing devices such as microprocessors, central processing units, processor cores, multiprocessors, ASICs, and FPGAs, but the scope of the disclosure is not limited thereto.

The memory 150 may be operably connected to the processor 140, and may store at least one code associated with operations performed by the processor 140.

The memory 150 may also function to temporarily or permanently store data processed by the processor 140. Here, the memory 150 may include a magnetic storage medium or a flash storage medium, but the scope of the disclosure is not limited thereto. The memory 150 may include internal memory and/or external memory, and may include volatile memory, such as DRAM, SRAM, or SDRAM, non-volatile memory, such as OTPROM, PROM, EPROM, EEPROM, mask ROM, flash ROM, NAND flash memory, or NOR flash memory, a flash drive, such as an SSD, a CF card, an SD card, a micro-SD card, a mini-SD card, an xD card, or a memory stick, or a storage device, such as an HDD.

In this embodiment, the power market price calculation device 100 may exist independently in the form of a server, or may be mounted on a user terminal (not shown) by implementing the power market price calculation function provided by the power market price calculation device 100 in the form of an application. The user terminal may be provided with a power market price calculation service by accessing the power market price calculation application and/or a power market price calculation website provided by the power market price calculation device 100. In this embodiment, the power market price calculation device 100 may further include a communication module (not shown) to perform communication with the user terminal.

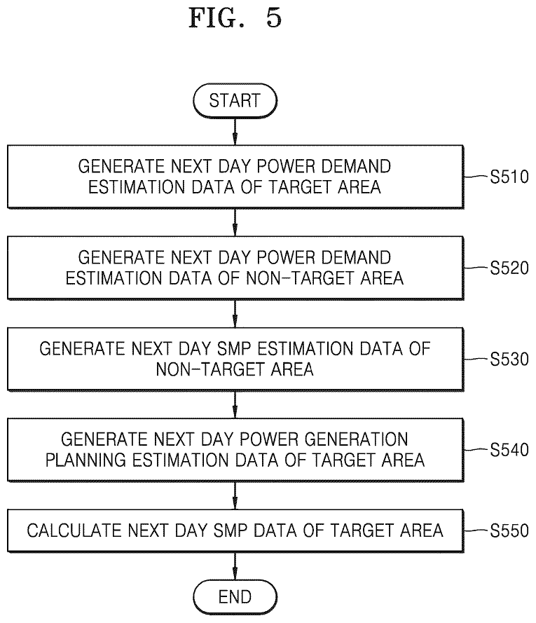

FIG. 5 is a flowchart illustrating a method of calculating a power market price based on photovoltaic power generation according to embodiments. In the following description, some portions which are the same as those described with reference to FIGS. 1 to 4 will be omitted. The method of calculating a power market price based on photovoltaic power generation according to this embodiment will be described by assuming that the power market price calculation device 100 is performed by the processor 140 with the assistance of peripheral components.

Referring to FIG. 5, in operation S510, the processor 140 may analyze the date data, the meteorological data, and the past power demand data to generate the next day power demand estimation data of the target area. In this embodiment, when generating the next day power demand estimation data of the target area, the processor 140 may generate the next day power demand data of the target area corresponding to the date data, the meteorological data, and the past power demand data using the first machine learning model which generates the next day power demand estimation data of the target area based on the date data, the meteorological data, and the past power demand data. Here, the first machine learning model may include a model trained by the supervised learning method using first training data having the date data, the meteorological data of the target area, the past power demand data of the target area, and area data as an input and the next day power demand data of the target area as a label.

In operation S520, the processor 140 may analyze the date data, the meteorological data, and the past power demand data to generate the next day power demand estimation data of the non-target area. In this embodiment, when generating the next day power demand estimation data of the non-target area, the processor 140 may generate the next day power demand estimation data of the non-target area corresponding to the date data, the meteorological data, and the past power demand data using the modified first machine learning model which generates the next day power demand estimation data of the non-target area based on the date data, the meteorological data, and the past power demand data. Here, the modified first machine learning model may include a model trained by the supervised learning method using training data having the date data, the meteorological data of the non-target area, and the past power demand data of the non-target area as an input and the next day power demand data of the non-target area as a label.

In operation S530, the processor 140 may analyze the next day power demand estimation data of the non-target area, the date data, the meteorological data, the past power demand data, and the past SMP data to generate the next day SMP estimation data of the non-target area. In this embodiment, when generating the next day SMP estimation data of the non-target area, the processor 140 may generate the next day SMP estimation data of the non-target area corresponding to the next day power demand estimation data of the non-target area, the date data, the meteorological data, the past power demand data, and the past SMP data using the second machine learning model which generates the next day SMP estimation data of the non-target area based on the next day power demand estimation data of the non-target area, the date data, the meteorological data, the past power demand data, and the past SMP data. Here, the second machine learning model may include a model trained by the supervised learning method using second training data having the next day power demand estimation data of the non-target area, the date data, the meteorological data of the non-target area, the past power demand data of the non-target area, and the past SMP data of the non-target area as an input and the next day SMP estimation data of the non-target area as a label.

In operation S540, the processor 140 may analyze the next day power demand estimation data of the target area, the generator characteristics data, and the system constraint data to generate the next day power generation planning estimation data of the target area. In this embodiment, when generating the next day power generation planning estimation data of the target area, the processor 140 may generate the next day power generation planning estimation data of the target area corresponding to the next day power demand estimation data of the target area, the generator characteristics data, and the system constraint data using the third machine learning model which generates the next day power generation planning estimation data of the target area based on the next day power demand estimation data of the target area, the generator characteristics data, and the system constraint data. Here, the third machine learning model may include a model trained by the supervised learning method using third training data having the next day power demand estimation data of the target area, the generator characteristics data of the target area, and the system constraint data of the target area as an input and the power generation planning data of the target area, including next day power generation amounts of generators disposed in the target area and next day shutdown results of the generators, as a label.

In operation S550, the processor 140 may calculate the next day SMP data of the target area by analyzing the next day power generation planning estimation data of the target area, the system constraint data, the generator characteristics data, and the next day SMP estimation data of the non-target area. In this embodiment, when calculating the next day SMP data of the target area, the processor 140 may determine respective generation prices of the plurality of generators included in the generator group based on the next day power generation planning estimation data of the target area, the system constraint data, and the generator characteristics data. Here, in determining the generation price, the processor 140 may calculate a first price incurred to increase the generator's daily generation amount included in the next day power generation planning estimation data of the target area. The processor 140 may calculate a second price incurred to compensate for any fuel cost deficit which may not be recovered using the first price. The processor 140 may calculate a third price incurred to start the generator. The processor 140 may determine the result of summing the first price, the second price, and the third price to be a generation price. In this embodiment, in determining the generation price, the processor 140 may exclude the second price and the third price from the generation price based on the generator characteristics data as one of the fixed constrained operating amount and the lower constrained operating amount is bid in the continuous startup time. Furthermore, the processor 140 may exclude the second price and the third price from the generation prices of the generators which must be operated essentially based on the system constraint data as the total number of operating generators included in the generator group is less than or equal to the number of essentially operating generators in the generator group.

After determining the respective generation prices of the plurality of generators, the processor 140 may determine one or more generation prices which satisfy the pricing conditions among the respective generation prices of the plurality of generators to be one or more system prices. In this embodiment, in determining the system prices, the processor 140 may exclude, from the system prices, generation prices which do not satisfy the pricing conditions among generation prices of the non-marginal generator indicator, including generators which are unnecessary to calculate the SMP, and generation prices of the system operating generator indicator, including generators which must be operated, based on the generator characteristics data and the system constraint data. In excluding from the system prices, the processor 140 may exclude, from the system prices, the generation price of a generator which is planned to generate an amount of power which is less than or equal to the sum of the minimum generation capacity, the planned primary reserve, the planned frequency control reserve, and the tolerance. The processor 140 may exclude, from the system prices, the generation price of a generator which is planned to generate an amount of power which is less than or equal to the sum of the fixed constrained operating amounts for times of day and the lower constrained capacity plus the tolerance. The processor 140 may exclude the generation prices of generators which are power generation planned to ramp up at full rate from the system prices. The processor 140 may exclude the generation prices of generators which are power generation planned to ramp down at full rate from the system prices. The processor 140 may exclude, from the system prices, the generation prices of a plurality of generators which are power generation planned so that the total of generation of the plurality of generators in the generator group is less than or equal to the minimum generation for times of day of the generator group. The processor 140 may exclude the generation prices of generators which are power generation planned to additionally operate to stabilize the power supply from the system prices. In this embodiment, after determining the one or more system prices, the processor 140 may determine the highest value of the one or more system prices to be the next day SMP data of the target area.

According to the disclosure, the power market price may be calculated more accurately by accurately reflecting the characteristics of power supply and demand of the target area to effectively manage the volatility of power supply and demand of the target area, thereby increasing price stability and reducing the cost burden of power consumers.

The power market price may be more accurately calculated by accurately reflecting the power supply and demand characteristics of the target area to optimize the integration of power resources, such as photovoltaic energy, thereby promoting economically and environmentally sustainable power supply.

Furthermore, the power market price may be calculated more accurately by accurately reflecting the power supply and demand characteristics of the target area, thereby contributing to improving the efficiency of the power market and increasing the transparency of power transactions.

The above-described embodiments according to the disclosure may be implemented in the form of a computer program which may be executed by various components on a computer, and such a computer program may be recorded on a computer-readable medium. Here, the medium may include magnetic media, such as hard disks, floppy disks, and magnetic tape, optical recording media, such as CD-ROMs and DVDs, magneto-optical media, such as floptical disks, and hardware devices specially configured to store and execute program instructions, such as ROM, RAM, and flash memory.

The computer program may be specially designed and configured for the disclosure, or may be known and available to a person of ordinary skill in the art of computer software. Examples of computer programs may include machine language code, such as that produced by a compiler, as well as high-level language code which may be executed by a computer using an interpreter or the like.

The use of the term “the” and similar reference terms in the specification (particularly the claims) of the disclosure are to be construed to cover both the singular and the plural. Furthermore, the specification of a range in the disclosure includes inventions in which individual values within the range are applied (unless otherwise indicated), as if each individual value within the range were specified in the detailed description.

The operations of the method according to the disclosure may be performed in any appropriate order, unless the order of the operations is explicitly stated or otherwise. The disclosure is not necessarily limited to the order in which the operations are described. The use of any examples or illustrative terms (e.g., and/or the like) herein is only for the purpose of describing the disclosure in detail and the scope of the disclosure is not limited to the examples or illustrative terms unless defined by the claims. Furthermore, a person of ordinary knowledge in the art will appreciate that various modifications, combinations, and alterations are possible depending on the design conditions and factors within the scope of the appended claims or equivalents thereof.

Therefore, it should be understood that the spirit of the disclosure is not limited to the foregoing embodiments, and the scope of the appended claims, as well as all scopes equivalent to or equivalently modified from the scope of the claims, are included within the scope of the spirit of the disclosure.

What is claimed is:

1. A method of calculating a power market price performed by a process of a power market price calculation device, the method comprising:
analyzing date data, meteorological data, and past power demand data to generate next day power demand estimation data of a target area;
analyzing date data, meteorological data, and past power demand data to generate next day power demand estimation data of a non-target area;
analyzing the next day power demand estimation data, the date data, the meteorological data, the past power demand data, and past system marginal price (SMP) data to generate next day SMP estimation data of the non-target area;
analyzing the next day power demand estimation data of the target area, generator characteristics data, and system constraint data to generate next day power generation planning estimation data of the target area; and
analyzing the next day power generation planning estimation data of the target area, the system constraint data, the generator characteristics data, and the next day SMP estimation data of the non-target area to calculate next day SMP data of the target area.

2. The method of claim 1, wherein the generating the next day power demand estimation data of the target area comprises
generating next day power demand data of the target area corresponding to the date data, the meteorological data, and the past power demand data using a first machine learning model which generates the next day power demand estimation data of the target area based on the date data, the meteorological data, and the past power demand data, and
the first machine learning model comprises
a model trained by a supervised learning method using first training data having the date data, the meteorological data of the target area, the past power demand data of the target area, and area data as an input and the next day power demand data of the target area as a label.

3. The method of claim 1, wherein the generating the next day SMP estimation data of the non-target area comprises
generating the next day SMP estimation data of the non-target area corresponding to the next day power demand estimation data of the non-target area, the date data, the meteorological data, the past power demand data, and the past SMP data using a second machine learning model which generates the next day SMP estimation data of the non-target area based on the next day power demand estimation data of the non-target area, the date data, the meteorological data, the past power demand data, and the past SMP data, and
the second machine learning model comprises
a model trained by a supervised learning method using second training data having the next day power demand estimation data of the non-target area, the date data, the meteorological data of the non-target area, the past power demand data of the non-target area, and the past SMP data of the non-target area as an input and the next day SMP estimation data of the non-target area as a label.

4. The method of claim 1, wherein the generating the next day power generation planning estimation data of the target area comprises
generating the next day power generation planning estimation data of the target area corresponding to the next day power demand estimation data of the target area, the generator characteristics data, and the system constraint data using a third machine learning model which generates the next day power generation planning estimation data of the target area based on the next day power demand estimation data of the target area, the generator characteristics data, and the system constraint data, and
the third machine learning model comprises
a model trained by a supervised learning method using third training data having the next day power demand estimation data of the target area, the generator characteristics data of the target area, and the system constraint data of the target area as an input and power generation planning data of the target area, comprising next day power generation amounts of generators disposed in the target area and next day shutdown results of the generators, as a label.

5. The method of claim 1, wherein the calculating the next day SMP data of the target area comprises:
determining respective generation prices of a plurality of generators included in a generator group based on the next day power generation planning estimation data of the target area, the system constraint data, and the generator characteristics data;
determining one or more generation prices which satisfy pricing conditions among the respective generation prices of the plurality of generators to be one or more system prices; and
determining a highest value of the one or more system prices to be the next day SMP data of the target area.

6. A computer-readable recording medium on which a computer program for executing the method of claim 1 using a computer is stored.

7. A power market price calculation device comprising:
at least one processor; and
at least one memory operably connected to the processor,
wherein the at least one processor is configured to:
analyze date data, meteorological data, and past power demand data to generate next day power demand estimation data of a target area;
analyze date data, meteorological data, and past power demand data to generate next day power demand estimation data of a non-target area;
analyze the next day power demand estimation data, the date data, the meteorological data, the past power demand data, and past system marginal price (SMP) data to generate next day SMP estimation data of the non-target area;
analyze the next day power demand estimation data of the target area, generator characteristics data, and system constraint data to generate next day power generation planning estimation data of the target area; and
analyze the next day power generation planning estimation data of the target area, the system constraint data, the generator characteristics data, and the next day SMP estimation data of the non-target area to calculate next day SMP data of the target area.

8. The device of claim 7, wherein the at least one processor is configured to,
in generating the next day power demand estimation data of the target area, generate next day power demand data of the target area corresponding to the date data, the meteorological data, and the past power demand data using a first machine learning model which generates the next day power demand estimation data of the target area based on the date data, the meteorological data, and the past power demand data, and
the first machine learning model comprises
a model trained by a supervised learning method using first training data having the date data, the meteorological data of the target area, the past power demand data of the target area, and area data as an input and the next day power demand data of the target area as a label.

9. The device of claim 7, wherein the at least one processor is configured to,
in generating the next day SMP estimation data of the non-target area, generate the next day SMP estimation data of the non-target area corresponding to the next day power demand estimation data of the non-target area, the date data, the meteorological data, the past power demand data, and the past SMP data using a second machine learning model which generates the next day SMP estimation data of the non-target area based on the next day power demand estimation data of the non-target area, the date data, the meteorological data, the past power demand data, and the past SMP data, and
the second machine learning model comprises
a model trained by a supervised learning method using second training data having the next day power demand estimation data of the non-target area, the date data, the meteorological data of the non-target area, the past power demand data of the non-target area, and the past SMP data of the non-target area as an input and the next day SMP estimation data of the non-target area as a label.

10. The device of claim 7, wherein the at least one processor is configured to, in generating the next day power generation planning estimation data of the target area, generate the next day power generation planning estimation data of the target area corresponding to the next day power demand estimation data of the target area, the generator characteristics data, and the system constraint data using a third machine learning model which generates the next day power generation planning estimation data of the target area based on the next day power demand estimation data of the target area, the generator characteristics data, and the system constraint data, and
the third machine learning model comprises
a model trained by a supervised learning method using third training data having the next day power demand estimation data of the target area, the generator characteristics data of the target area, and the system constraint data of the target area as an input and power generation planning data of the target area, comprising next day power generation amounts of generators disposed in the target area and next day shutdown results of the generators, as a label.

11. The device of claim 7, wherein the at least one processor is configured to,
in calculating the next day SMP data of the target area, determine respective generation prices of a plurality of generators included in a generator group based on the next day power generation planning estimation data of the target area, the system constraint data, and the generator characteristics data,
determine one or more generation prices which satisfy pricing conditions among the respective generation prices of the plurality of generators to be one or more system prices, and
determine a highest value of the one or more system prices to be the next day SMP data of the target area.
